(19) United States
(12) Patent Application Publication
(10) Pub. No.: US 2016/0109665 A1
(43) Pub. Date: Apr. 21, 2016

(54) OPTICAL MODULE WITH GLASS SLIDE

(71) Applicant: FOXCONN INTERCONNECT TECHNOLOGY LIMITED, Grand Cayman (KY)

(72) Inventors: CHUN-YI CHANG, New Taipei (TW); JIA-HAU LIU, New Taipei (TW)

(21) Appl. No.: 14/884,774

(22) Filed: Oct. 16, 2015

(30) Foreign Application Priority Data
Oct. 16, 2014 (TW) 103135779

(51) Int. Cl. G02B 6/42; G02B 6/32; G02B 6/30

(52) U.S. Cl. CPC G02B 6/428; G02B 6/30; G02B 6/4259; G02B 6/4269; G02B 6/4292; G02B 6/32; G02B 6/4214

(57) ABSTRACT

An optoelectronic assembly includes a printed circuit board (PCB), a glass carrier positioned upon the PCB and equipped with thereon an active component and an Integrated Circuit (IC) linked to each other via the flip chip technology, an optical waveguide embedded within the PCB, and a ferrule located around the optical waveguide to couple an external optical device thereto for optical transmission therebetween.

### BACKGROUND OF THE INVENTION

1. Field of the Invention

The present invention relates to an optoelectronic assembly, and particularly to the optoelectronic assembly with superior heat dissipation. The invention relates to the copending application titled “OPTICAL MODULE ASSEMBLY WITH IMPROVED PRINTED CIRCUIT BOARD” having the same filing date and the same inventors and the same applicant with the instant application.

2. Description of Related Art

The traditional optoelectronic assembly includes a printed circuit board (PCB) equipped with the active component, e.g., the vertical-cavity surface-emitting laser (VCSEL) or PIN (p-doped-intrinsic-n-doped) photodetectors, and integrated circuit (IC) linked by the wire:bond. Firstly, the wire-bond is slender with high resistance thereof, thus resulting in high inductance which is not fit for high frequency transmission. Secondly, via such wire-bonds, it is required to have both the active component and IC face up so as to have the heat-dissipation surfaces of both the component and the IC directly seated upon the printed circuit board, thus jeopardizing the efficiencies of the heat dissipation thereof Thirdly, because the active component and IC face up, the corresponding lens is required to be seated upon/above the active component, thus hindering, inspection of the interior size, current and voltage of the active component and the corresponding repairing and adjustment if the VCSEL becomes defective.

Hence, an improved optoelectronic assembly is desired to overcome the foregoing drawbacks.

### BRIEF SUMMARY OF THE INVENTION

Accordingly, an object of the present invention is to provide an improved optoelectronic assembly which is adapted to be used in high frequency transmission and be repaired/adjusted.

In order to achieve the above-mentioned object, an optoelectronic assembly includes a printed circuit board (PCB), a glass carrier positioned upon the PCB and equipped with thereon an active component and an Integrated Circuit (IC) linked to each other via the flip chip technology, an optical waveguide embedded within the PCB, and a ferrule located around the optical waveguide to couple an external optical device thereto for optical transmission therebetween.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an optoelectronic assembly of a presently preferred embodiment of the invention;

FIG. 2 is an exploded perspective view of the optoelectronic assembly of FIG. 1;

FIG. 3 is another exploded perspective of the optoelectronic assembly of FIG. 1;

FIG. 4 is a cross-sectional view of the optoelectronic assembly of

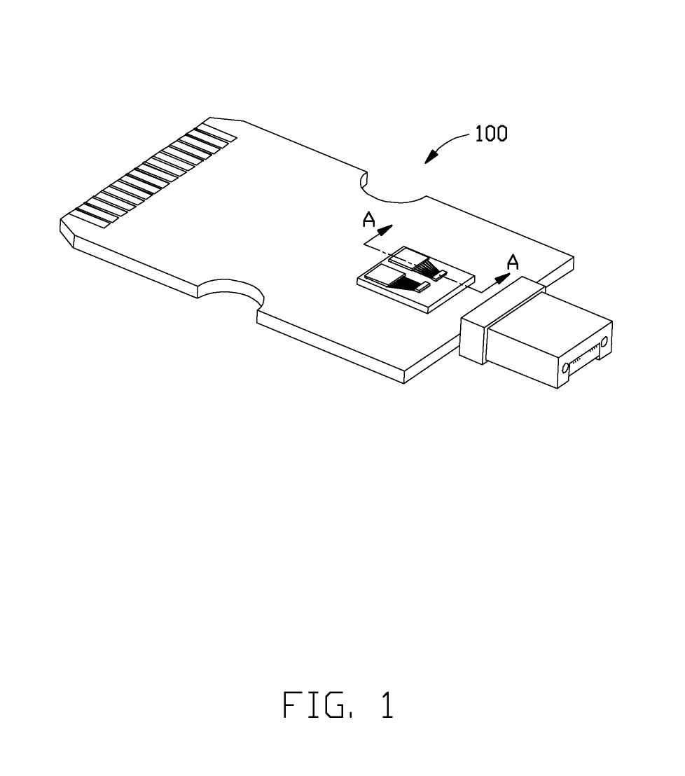

FIG. 1.

### DETAILED DESCRIPTION OF THE PREFERRED EMBODIMENT

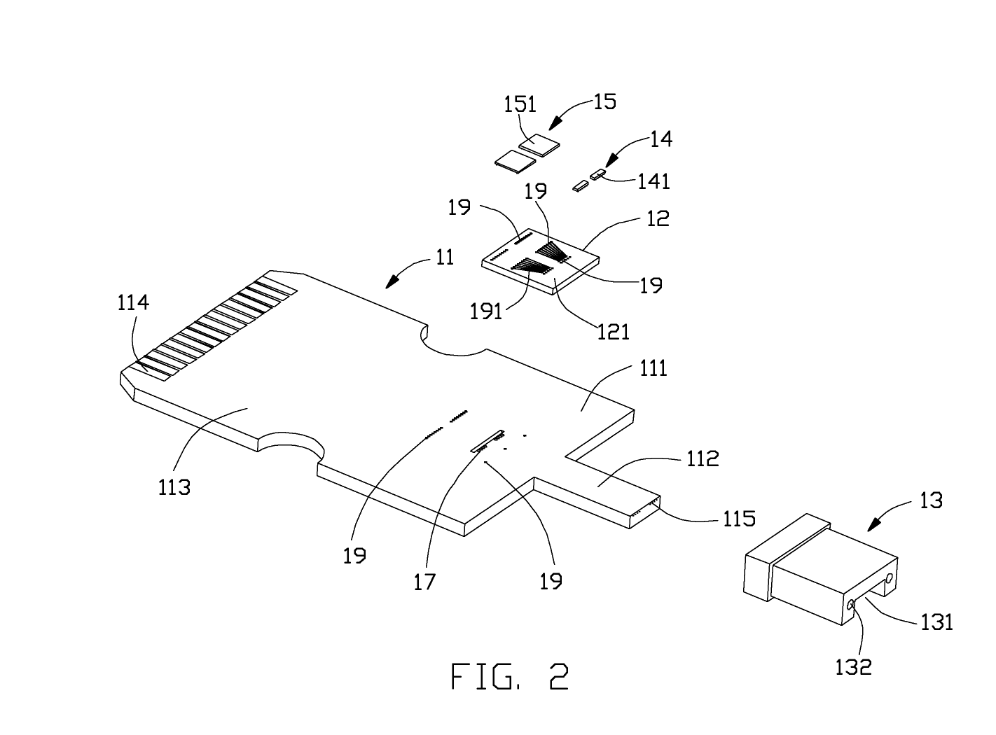

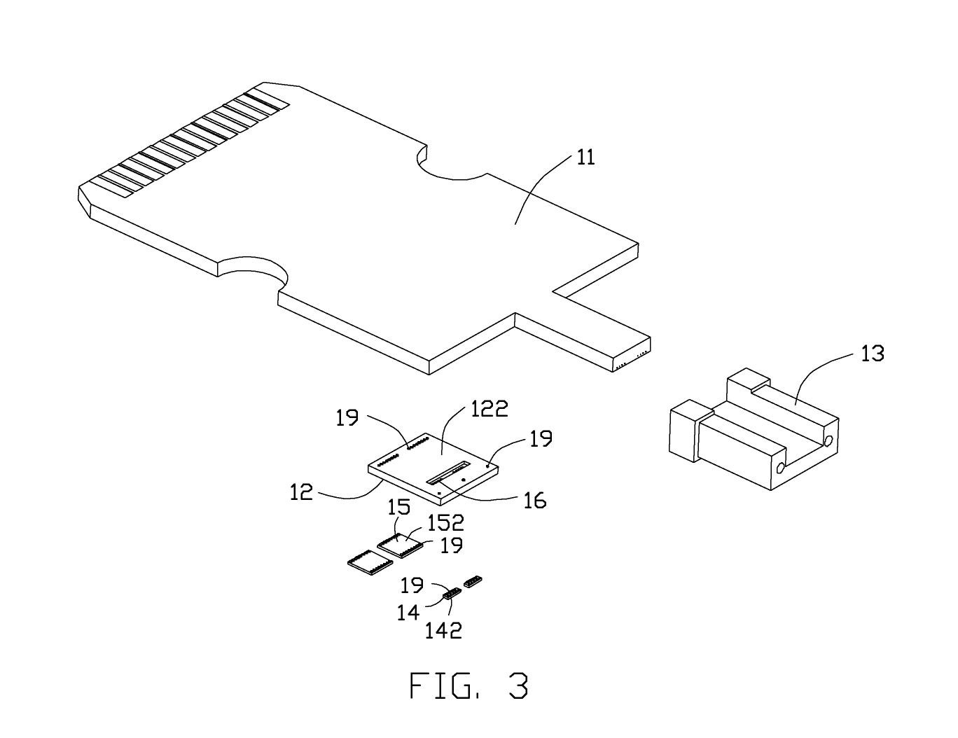

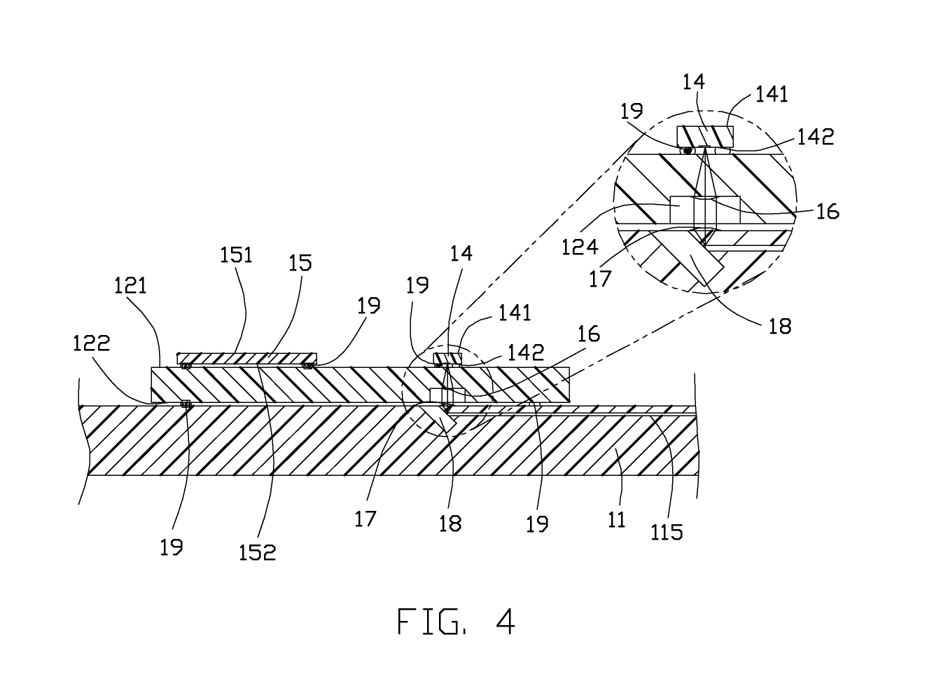

Referring to FIGS. 1 through 4, an optoelectronic assembly 100 includes a printed circuit board 11 (PCB), a glass carrier 12 mounted upon the PCB 11, an active component 14 and an Integrated Circuit (IC) 15 mounted upon the glass carrier 12, and a ferrule 13 mounted upon one end of the PCB 11 for coupling to an optical part (not shown).

An optical waveguide 115 is embedded within the PCB 11. The PCB 11 includes a wide portion 111 and the narrow portion 112. The wide portion includes an upper surface 113 with conductive pads 114 thereon to be an electrical connection port for mating with an electrical connector (not shown). The glass carrier 12 is mounted upon the upper surface 113. The ferrule 13 is mounted upon the narrow portion 112 as an optional connection port, and includes a receiving space 131 to receive the narrow portion 112 therein, and a pair of alignment holes 132 into which a pair of alignment posts (not shown) of the aforementioned optical part (not shown) are inserted.

The active component 14 forms opposite upper surface 141 and lower surface 142 wherein the upper surface 141 is for heat dissipation and the lower surface 142 is for mounting to the glass carrier 12. Similarly, the IC 15 forms opposite upper surface 151 and lower surface 152 wherein the upper surface 151 is for heat dissipation and the lower surface 152 is for mounting to the glass carrier 12. The glass carrier 12 forms opposite upper surface 121 and lower surface 122 wherein the active component 14 and the IC 15 are mounted upon the upper surface 121 via the solder balls 19. The active component 14 and the IC 15 are electrically connected with each other via conductive traces 191 printed upon the upper surface 121. The lower surface 122 is mounted upon the PCB 11 via the solder balls 19. The solder balls 19 on the lower surface 122 are electrically connected to the corresponding solder balls 10 on the upper surface 121 via the traces or vias within the glass carrier 12.

A first lens 16 is unitarily formed within a recess 124 of the glass carrier 12, and a second lens 17 is molded upon the upper surface 112 of the PCB 11 and vertically communicatively coupling with the optical waveguide 115 via a reflector 18 which is located in a 45-degree recess, which may be formed via the laser processing, around the upper surface 112. The active component 14, the first lens 16 and the second lens 17 are aligned together in the vertical direction. During operation, the light from the waveguide 115 hits the second lens 17 via the reflector 18, and successively hits the first lens 16 and finally enters the active component 14, e.g., the photo-detector, to convert the optical signals to the electrical signals. The electrical signals are transmitted to the PCB 11 via the IC 15. Notably, such operation may be implemented vice versa if the active component 14 is the VCSEL.

In the invention, the active component 14 and the IC 15 are mounted upon the glass carrier 12, and the glass carrier 12 is mounted upon the PCB 11 wherein the active component 14 and the IC 15 being essentially at the same level, are electrically connected via conductive traces, and the IC 15 and the PCB 11 being essentially vertically offset from each other, are electrically connected via the solder balls 19 and the vias/traces. From a viewpoint, the PCB 11 forms opposite optical side and electrical side respectively coupling to the outer optical part and the outer electrical part, and the glass carrier 12 also forms opposite optical side and the electrical side essentially corresponding to those of the PCB 11 wherein the glass carrier 12 forms an optical transmission path on the optical side for optically connecting the active component 14 with the waveguide 115, and an electrical transmission path on the electrical side for electrically connecting the IC 15 with the corresponding traces on the PCB 11. The active component 14 is mounted upon and vertically aligned with the optical side of the glass carrier 12 while the IC 15 is mounted upon and vertically aligned with the electrical side of the glass carrier 12.

Compared with the traditional design using the wire-bonds, the invention may lower the value of the inductance for high frequency transmission. In addition, the heat dissipation surfaces of the active component 14 and the IC 15 are the upper surfaces 141 and 151 which is upwardly exposed to an exterior, thus assuring superior heat dissipation. Moreover, when such operation is out of order, it is easy to identify where the defect is located, either on the glass carrier 12 side or on the PCB 11 side, by disassembling the glass carrier 12 from the PCB 11 and inspecting them individually.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An optoelectronic assembly comprising:
a printed circuit board (PCB);
a carrier mounted upon the PCB in a vertical direction;
an active component for optoelectronic conversion mounted upon the carrier with a heat dissipation surface opposite to the PCB and exposed to an exterior; and
an integrated circuit (IC) mounted upon the carrier and electrically connected to the active component via conductive traces.

2. The optoelectronic assembly as claimed in claim 1, wherein the carrier is equipped with a first lens aligned with the active component in the vertical direction, and a second lens is formed on the PCB aligned with the first lens in the vertical direction for light transmission therebetween.

3. The optoelectronic assembly as claimed in claim 2, wherein the PCB is equipped with an optical waveguide extending along a horizontal direction perpendicular to said vertical direction, and said waveguide is coupled to the second lens via a reflector embedded within a recess of the PCB.

4. The optoelectronic assembly as claimed in claim 3, wherein a ferrule is provided on one end of the PCB around said waveguide to form an optical connection port.

5. The optoelectronic assembly as claimed in claim 4, wherein the PCB forms conductive pads as an electrical connection port which is opposite to an optical connection port wherein

6. The optoelectronic assembly as claimed in claim 1, wherein the carrier is made from glass.

7. The optoelectronic assembly as claimed in claim 1, wherein the carrier and the IC are mounted upon the carrier via soldering.

8. The optoelectronic assembly as claimed in claim 1, wherein the carrier is mechanically secured and electrically connected to the PCB via soldering around the IC.

9. An optoelectronic assembly comprising:
a printed circuit board (PCB) defining an optical connection port and an electrical connection port;
a carrier mounted upon the PCB in a vertical direction, and defining opposite optical side and electrical side in a horizontal direction perpendicular to said vertical direction, corresponding to said optical connection port and said electrical connection port;
an active component for optoelectronic conversion mounted upon the optical side of the carrier; and
an integrated circuit (IC) mounted upon the electrical side of the carrier; wherein
the active component and the IC are electrically connected via conductive traces.

10. The optoelectronic assembly as claimed in claim 9, wherein the both the active component and the IC are opposite to the PCB with the carrier therebetween in the vertical direction so as to have corresponding heat dissipation surfaces thereof exposed to an exterior.

11. The optoelectronic assembly as claimed in claim 10, wherein an optical transmission path is formed on the optical side and an electrical transmission path is formed on the electrical side.

12. The optoelectronic assembly as claimed in claim 11, wherein in said optical transmission path, a first lens is located on the carrier and a second lens is formed on the PCB.

13. The optoelectronic assembly as claimed in claim 12, wherein said PCB is further equipped with an optical waveguide coupling to the second lens via a reflector and exposed to the optical connection port.

14. The optoelectronic assembly as claimed in claim 13, wherein the optical connection port is equipped with a ferrule communicating with the waveguide.

15. The optoelectronic assembly as claimed in claim 12, wherein said carrier is made of glass on which the first lens is unitarily formed.

16. An optoelectronic assembly comprising:
a printed circuit board (PCB);
a carrier mounted upon the PCB in a vertical direction;
an active component for optoelectronic conversion mounted upon the carrier with a heat dissipation surface opposite to the PCB and exposed to an exterior; and
a first lens located under the active component and between the carrier and the PCB in the vertical direction.

17. The optoelectronic assembly as claimed in claim 16, wherein a plurality of conductive trances are formed on the carrier and connected to the active component.

18. The optoelectronic assembly as claimed in claim 17, wherein an integrated circuit (IC) is mounted upon the carrier and electrically connected to the conductive traces.

19. The optoelectronic assembly as claimed in claim 16, wherein a second lens is formed on the PCB aligned with the first lens in the vertical direction.

20. The optoelectronic assembly as claimed in claim 19, further including an optical waveguide in the PCB to be coupled to the second lens via a reflector.
